(19) United States
(12) Patent Application Publication
(10) Pub. No.: US 2004/0028919 A1
(43) Pub. Date: Feb. 12, 2004

(54) Surface protective film for transparent conductive substrate, and transparent conductive substrate with surface protective film

(76) Inventors: Mitsushi Yamamoto, Osaka (JP); Shinichi Takada, Osaka (JP); Kazuhito Okumura, Osaka (JP); Masaki Hayashi, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/618,957

(22) Filed: Jul. 14, 2003

(30) Foreign Application Priority Data
Aug. 9, 2002 (JP) 2002-233281

(51) Int. Cl. B32B 15/08

(52) U.S. Cl. 428/458; 428/500

(57) ABSTRACT

To provide a surface protective film for transpar nt conductive substrates having sufficient transparency and heat resistance, and not demonstrating white turbiness, even when it is placed under a heated environment in a state where the surface protective film is attached on the transparent conductive substrate.

A surface protective film for transparent conductive substrates protecting a surface on a side opposite to a conductive thin film or a surface on a side of the conductive thin film of the transparent conductive substrate, wherein an adhesive layer is formed on one side of a base material film, and an antistatic layer is formed on the other side.

### BACKGROUND OF THE INVENTION

1. Field of the Invention

The present invention relates to a surface protective film used for transparent conductive substrate and to a transparent conductive substrate with the surface protective film that are widely used in a field of a transparent electrode and the like, such as liquid crystal displays, plasma display panels, touch panels, sensors, and solar cells.

2. Prior Art

Generally, a transparent conductive substrate has a structure where a conductive thin film 2b comprising ITO etc. is formed on one side of a substrate 2a comprising films, such as polyesters, or glass, and hard coat layer 2c (or an anti-glare layer) on the other side is formed, as shown in FIG. 3. In such a transparent conductive substrate 2, surface protective films are conventionally used for the hard coat layer 2c on a side opposite to the conductive thin film 2b, or on the anti-glare layer in order to prev nt adhesion of foreign matter and soil. As the abov-mentioned surfa e protective film, for example, two-lay red tapes omprising polyethylene/ethylene-vinylacetate opolymer (PE/EVA) by a o-extrusion method are used.

When a transparent conductive substrate constituting an adherend of the above-mentioned surface protective film is used, for example, for manufacturing touch panels, it will be provided with a silver ink printed thereon and subjected to drying by heating processes in a plurality of processes in order to form a electrode in the manufacturing process. A heated condition is in a temperature range of 90 through 150° C., and residence time at each drying process is in a range of 10 through 30 minutes, and total period is about 1 hour. In such drying by heating processes, however, since the above-mentioned surface protective film is melted or greatly deformed, it cannot be used in the above-mentioned heating processes.

Then, surface protective films of heat-resistant high polyethylene terephthalate (PET) etc. as raw material component have been examined, but there has been shown a tendency of demonstrating white turbiness of a base material film after drying by heating caused by deposition and crystallization of oligomers existing in the base material film onto a surface of the base material film. Thereby, there occurred problems that:

1) difficulty in visual inspection of the transparent conductive substrate;

2) considerabl decrease in workability aused by oligomers separated during the inspection of the transparent conductive substrate; and

3) possibility of ontamination given to the transparent condu tive substrate by oligomers separated even during the processes.

Since conventional surface protective films had the above-mentioned problems, the surface protective films could be used before and after heating process, but the surface protective film was difficult to be used in heating process. Accordingly, during the heating process, transparent conductive substrates could not be protected from neither scratch nor soil, and further necessity for the surface protective film to be attached and changed in the heating process provided great complicated work, which led to decrease in working efficiency and yield, and also high manufacture cost.

### SUMMARY OF THE INVENTION

The present invention aims at providing a surface protective film for transparent conductive substrates having sufficient transparency and heat resistance, and does not demonstrate white turbiness, which provides excellent workability for subsequent processes even when it is placed under a heated environment in a state of being attached on a transparent conductive substrate as an adherend. This invention also aims at providing a transparent conductive substrate with the surface protective film.

As a result of wholehearted research performed by the present inventors, it was found out that formation of an antistatic lay r on one side of a base material film of a surface prote tive film might solve the above-mentioned problems, l ading to completion of this invention.

That is, a surface protective film for transparent conductive substrates of this invention is a film that protects a surface on a side opposite to a conductive thin film or a surface of the conductive thin film of the transparent conductive substrate, wherein an adhesive layer is formed on one side of a base material film, and an antistatic layer is formed on the other side.

On the other hand, a transparent conductive substrate with a surface protective film of this invention comprises a conductive thin film on one side of a surface of a base material film, and a hard coat layer or an anti-glare layer on the other side, and at the same time, a adhesive layer of the above-mentioned surface protective film for the transparent conductive substrate is attached on a surface of the above-mentioned hard coat layer, anti-glare layer, or on a surface of the conductive thin film.

Furthermore, another transparent conductive substrate with a surface protective film of this invention comprises a conductive thin film on one side of the substrate, and at the same time, an adhesive layer of the above-mentioned surface protective film for a transparent conductive substrate is attached on a surface on the other side of the substrate, or on a surface on a side of the conductive thin film.

Function and Effect

A surface prote tive film for transparent onductive substrates of the present invention (abbreviated as “surface protective film” for short hereinafter) has antistatic effect by forming an antistatic layer thereto, and further it has an especially remarkable effect that deposit of oligomers existing in a base material film to a surface of the base material film is controlled even under heated environment. Accordingly, the surface protective film does not demonstrate white turbiness and maintains sufficient transparency even after heating processes, which therefore makes visual inspection of the transparent conductive substrate easier, and prevents separation of the oligomers in the inspection process and manufacturing process of the transparent conductive substrate. Besides, the transparent conductive substrate can be protected from scratch or soil during the heating processes. Although time and effort for attaching and exchanging surface protective films before and after the heating process was needed in conventional processes, the surface protective film may be subjected to the following heating process in a state being attached on the transparent conductive substrate. Thereby, time and effort for attaching and exchanging the surface protective film may be saved, leading to remarkable improvement in workability.

Besides, in this invention, it is preferable that the base material films for the surfa e protective film are films in luding polyethylene terephthalates and/or polyethylene naphthalates. Practically sufficient transparency and pra tically suffi ient strength and heat resistance may be obtained using the polymers.

### BRIEF DESCRIPTION OF THE DRAWINGS

FIG. 1 is a sectional view showing an example of used condition of a surface protective film for transparent conductive substrate of the present invention;

FIG. 2 is a sectional view showing an another example of used condition of a surface protective film for transparent conductive substrates of this invention; and

FIG. 3 is a sectional view showing an example of a transparent conductive substrate for which a surface protective film is not used.

### DESCRIPTION OF THE PREFERRED EMBODIMENTS

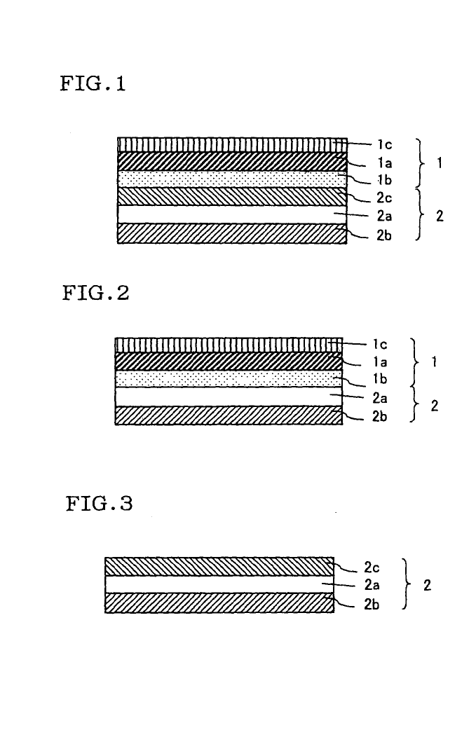

Hereinafter, description will be given about embodiments of the present invention, referring to drawings. FIG. 1 is a sectional view showing an example of used condition of a surface protective film of this invention, and FIG. 2 is a sectional view showing an another example of used condition.

In a surface protective film of this invention, as shown in FIG. 1, an adhesive layer 1b is formed on one side of a base material film 1a, and an antistatic layer 1c is formed on the other side. The surfa e prote tive film of this invention protects a surface opposite to a conductive thin film of a transparent condu tiv substrate, or a surface on a side of the conductive thin film. An embodiment shown in FIG. 1 shows an example in which a surface protective film 1 is attached on a surface of a hard coat layer 2c (or the above-mentioned anti-glare layer) of a transparent conductive substrate 2, and an embodiment shown in FIG. 2 shows an example in which a surface protective film 1 is attached on a surface of a substrate 2a of a transparent conductive substrate 2.

A base material film 1a is not especially limited, as long as it is a film having heat resistance and transparency practically required as an intended use for optics, for example, polyesters, such as polyethylene terephthalates (PET) and polyethylene naphthalates (PEN); polyphenylene sulfides (PPS), polycarbonates, polyamides, polyimides, polysulfones, polyethersulfones, etc. may be mentioned.

In this invention, in view of transparency, heat resistance, and strength, a base material film 1a is preferably a film including PET and/or PEN, and PET is particularly preferable in respect of low price and high versatility.

A thickness of a base material film 1a is not especially limited, and it is preferably about 10 through 200 μm, more preferably about 15 through 100 μm, and still more preferably about 20 through 70 μm. Excessively small thickness gives tendency for strength to be inadequate at a time of separation of a surfa e prot tive film 1 and for surfa protection fun tion to be inferior. And on the ther hand, excessively large thi kness gives a t nden y to be disadvantageous in respe t of handling property or cost. In the base material film 1a, in vi w of anchoring property between an adhesive layer 1b and an antistatic layer 1c, treatments by corona discharge, electron beam irradiation, sputtering methods, etc. and an adhesion-enhancing treatment are preferably performed on the surface of the base material film.

As adhesives forming the adhesive layer 1b, usually used adhesives for re-peeling (acrylics based, rubber materials based, synthetic rubbers based, etc.) may be used without particular restriction. Acrylic based adhesives whose adhesive power may be easily controlled based on compositions are preferable.

A weight average molecular weight of base polymers of acrylic based adhesives is preferably approximately 300,000 through 2,500,000. Various alkyl (meth)acrylates may be used as monomers used for acrylic based polymers as base polymers of the acrylic based adhesives. As examples of the alkyl (meth)acrylates, methyl (meth)acrylate, ethyl (meth)acrylate, butyl (meth)acrylatel, and 2-ethylhexyl (meth)acrylate etc. may be mentioned, and moreover they may be used independently or may be used in combination.

As acrylic based adhesives, a copolymer in which monomers including functional groups is copolymerized to the above-mentioned acrylic based polymer is used as base polymers, and preferably cr ss-linking agents for cross-linking with the functional groups of the monomers including functional groups may be blended.

As monomers having functional gr ups, monomers in luding carboxyl groups, hydroxyl groups, epoxy groups, amino groups etc. may be mentioned.

As monomers having carboxyl groups, acrylic acid, methacrylic acid, fumaric acid, maleic acid, itaconic acid, etc. may be mentioned.

As monomers having hydroxyl groups, there may be mentioned: 2-hydroxyethyl (meth)acrylate, hydroxybutyl (meth)acrylate, hydroxyhexyl (meth)acrylate, and N-methylol (meth) acrylamide etc. and as monomers including epoxy groups there may be mentioned glycidyl (meth)acrylate etc.

Also monomers including N element may be copolymerized with the above-mentioned acrylic based polymers. As monomers including N element, there may be mentioned: (meth)acrylamide, N,N-dimethyl (meth) acrylamide, N,N-diethyl (meth)acrylamide, (meth)acryloyl morpholine, (meth)acetonitrile, vinyl pyrrolidone, N-cyclohexyl maleimide, itaconimide, N,N-dimethylaminoethyl (meth) acrylamide etc. In addition, vinyl acetate, styrene, etc. may further be used for acrylic based polymers in a range not impairing performance of adhesives. These monomers may be used independently, and two or more of them may be used in combination.

Although a perc ntage of the above-mentioned opolymerizable monomer in a rylic bas d polymers is not especially limited, it is preferably approximately 0.1 through 12 parts by weight, and more pref rably 0.5 through 10 parts by weight to alkyl (meth)acrylate 100 parts by weight.

As cross-linking agents, epoxy based cross-linking agents, isocyanate based cross-linking agents, imine based cross-linking agents, metal chelate based cross-linking agents, etc. may be mentioned. Moreover, as cross-linking agents, polyamine compounds, melamine resins, urea resins, epoxy resins, etc. may be mentioned. Among cross-linking agents, epoxy based cross-linking agents are preferred. Although a mixing percentage of the cross-linking agent to the acrylic based polymers is not especially limited, an amount of the cross-linking agent (solid content) is preferably approximately 0.01 through 10 parts by weight to the acrylic based polymer (solid content) 100 parts by weight. In order to obtain cross-linking with high density, it is preferable to set the above-mentioned mixing percentage of the cross-linking agent as no less than 3 parts by weight.

Furthermore, tackifiers, plasticizers, fullers, antioxidants, UV absorbents, silane coupling agents, etc. may also be suitably used for the above-mentioned adhesives, if needed.

Methods for forming the adhesive layer 1b is not especially limited, and following methods may be mentioned:

(transfer method) a method in which an adhesive is applied to a siliconized poly ster film, and is transferr d onto a base material film 1a after dryed;

(dire t method) a method in whi h a adh sive omp sition is dir ctly applied to a base material film 1a, and then dried; and a method using a co-extrusion process.

Although a thickness of the adhesive layer 1b is not especially limited, it is preferably approximately 3 through 100 μm, and more preferably approximately 5 through 40 μm. An excessively small thickness of the adhesive layer 1b makes formation of an applied layer difficult, and there is tendency for inadequate adhesive power to be demonstrated. Excessively large thickness has tendency of providing excessive high adhesive power, which leads to tendency to give disadvantage in cost.

Besides, in a surface protective film 1 of this invention, the above-mentioned adhesive layer 1b may also be protected by a separator.

An antistatic layer 1c may be formed using following methods; a method in which antistatic agents, such as surface active agents, conductive carbon, and metal powders, are blended with polymers usually used, such as polyesters, and then the layer is formed on a base material film 1a; a method in which surface active agents and conductive resins are applied on a base material film 1a, and then is dried; and a method in which conductive substances, such as metals and conductive metal oxides, are applied, vapor-deposited, or plated on a base material film 1a.

As antistatic agents, any of the above-m ntioned antistatic agents may be used, as long as antistati ffect n eded is demonstrated and white turbiness formation aused by surface deposit of oligomers existing in the base material film an be prevented under heated environment.

As the above-mentioned surface active agents, specifically following examples may be mentioned; anionic or amphoteric compounds, such as carboxylic acid based compounds, sulfonic acid based compounds, and phosphate based salts; cationic based compounds, such as amine based compounds or quaternary ammonium salts; nonionic compounds, such as fatty acid polyhydric alcohol ester based compounds or polyoxyethylene addition products; and high polymer based compounds, such as polyacrylic acid derivatives.

In addition, it is preferable that antistatic agents include polymers having pyrrolidium rings in a main chain thereof. As polymers having pyrrolidium rings in a main chain, for example, “SHALLOL” etc. by Dai-Ichi Kogyo Seiyaku Co., Ltd. may be mentioned.

Besides, in order to raise adhesion between a base material film and an antistatic layer, it is also preferable to use antistatic agents obtained by blending polyvinyl alcohol based polymers as binders with cationic based compounds, such as quaternary ammonium base salts. As such base material films, for example, “T100G” etc. manufactured by Mitsubishi Chemical Polyester Film Co., Ltd., may be mentioned.

As conductiv resins, there may b mentioned resins in whi h onductive fillers, su h as tin antimony based fillers and indium oxide bas d fill rs in polymers.

Examples as conductive substances to be applied, vapor-deposited or plated includes tin oxides, indium oxides, cadmium oxides, titanium oxides, metal indiums, metal tin, gold, silver, platinum, palladium, copper, aluminum, nickel, chromium, titanium, iron, cobalt, copper iodide, and alloys or mixtures of the above-mentioned substance. Besides, they may be used independently or may be used in combination. As types of the above-mentioned vapor-deposition or plating; vacuum deposition, sputtering, ion plating, chemical vacuum deposition, spray pyrolysis, chemical plating, electroplating, etc. may be mentioned.

Although a thickness of an antistatic layer 1c is not especially limited, it is preferably approximately 0.005 through 5 μm, and more preferably approximately 0.01 through 1 μm.

On the other hand, a transparent conductive substrate 2 protected by a surface protective film 1 of this invention is shown in FIG. 1 or 2. That is, as shown in FIG. 1, a transparent conductive substrate with a surface protective film of this invention comprises a conductive thin film 2b on one side, and a hard coat layer 2c (or an anti-glare layer) on the other side of a substrate 2a, and at the same time a adhesive layer 1b of a surface protective film 1 attached on a surface of the hard coat layer 2c (or the anti-glare layer). Alternatively, a transparent onductive substrate with a surface protective film of this invention omprises a ondu tive thin film 2b on one side of a substrate 2a, and at the sam time an adhesive layer 1b of a surfa e prot ctive film 1 attached on a surface on the other side of the substrate 2a. Besides, a transparent conductive substrate with a surface protective film of this invention may comprise a adhesive layer 1b of the above-mentioned surface protective film 1 attached on a surface on a side of the conductive thin film 2b.

The conductive thin film 2b is formed with thin film of metal oxides, such as ITO (oxide of indium and tin) oxide of tin-antimony, zinc, tin and the like, and ultra-thin film of metals, such as gold, silver, palladium, and aluminum. These are formed by a vacuum deposition method, an ion beam deposition method, a sputtering method, an ion plating method, etc. Although a thickness of the conductive thin film 2b is not especially limited, it is in general no less than 50 Å, and preferably 100 through 2,000 Å.

As the substrate 2a, a film or a glass comprising transparent materials is usually used. As examples of the film, for example, polyesters, such as polyethylene terephthalates and polyethylene naphthalates; polymethylmethacrylates; styrene based polymers, such as polystyrenes and acrylonitrile styrene copolymers (AS resins); polycarbonates etc. may be mentioned. And there also may be mentioned: polyethylenes, polypropylenes, polyolefins having yclo based or norbornene structure; polyolefins like thyl ne propylen copolymers; vinyl chlorid based polymers; amid based polymers, such as nylons and aromati polyamides; imide based polymers;

sulfone based polymers; polyethersulfone based polymers; polyetheretherketone based polymers; polyphenylene sulfide based polymers; vinyl alcohol based polymers; vinylidene chloride based polymers; vinyl butyral based polymers; allylate based polymers; polyoxymethylene based polymers; epoxy based polymers; and blended materials of the above-mentioned polymers.

Although a thickness of the substrate 2a is not especially limited, it is in general approximately 10 through 1,000 μm, and preferably 20 through 500 μm.

As the hard coat layer 2c, other than layers having only hard coat function, a layer simultaneously having anti-glare function, a layer in which an anti-glare layer may be formed on the surface of a hard coat layer 2c.

As hard coat agents used, usual coating materials of ultraviolet radiation (UV) and electron rays curing type, silicone based hard coat agents, and phosphazene resin based hard coat agents etc. may be used, and in view of material cost, easiness in process, free selection of composition, etc. coating materials of UV curing type are preferable. The coating materials of UV curing type include vinyl polymerizable type, polythiol-polyene type, epoxy type, and amino-alkyd type, and they also may be classified into type of alkyd, polyester, polyether, acryli, urethane, and epoxy according to types of prepolymer, any types of which may be usable.

Besides, an anti-glare layer represents a layer having functions, such as prevention of dazzling, and antireflection. Specifically, for example, a layer using a refractive index difference between layers, a layer using a refractive index difference between fine-grains included and a polymer forming the layer, a layer that has detailed valleys and peaks form on a surface thereof may be mentioned.

A transparent conductive substrate 2 of this invention may be used for new display methods, such as liquid crystal displays, plasma display panels, and electroluminescence displays, for transparent electrode in touch panels, sensors, solar cells, etc., and further for electrification prevention of transparent articles, electromagnetic wave interception, etc.

### EXAMPLE

Hereinafter, description will be given for Examples showing concrete constitution and effect of this invention.

[Preparation of Acrylic Based Adhesive]

Using a commonly used method, butyl acrylate (100 parts by weight) and acrylic acid (6 parts by weight) were copolymerized in ethyl acetate to obtain a solution (30% by weight of solid content) of an acrylic based copolymer having a weight average molecular weight of 600,000 (polystyrene converted). TETRAD C (made by Mitsubishi Gas Chemical Company Inc.) 6 parts by weight as epoxy based ross-linking agent was added to the a ryli based opolymer 100 parts by weight (solid ontent), and a adhesive omposition was obtained.

### Example 1

The above-mentioned acrylic based adhesive composition was applied to a non-antistatic surface of a polyester film having an antistatic layer attached on one side (manufactured by Mitsubishi Chemical Polyester Film Corporation, T100G, thickness 38 μm) with a coating machine so that a thickness after dried might be 20 μm, and then dried to obtain a surface protective film.

### Comparative Example 1

The above-mentioned acrylic based adhesive composition was applied to one side of a polyester film (manufactured by Teijin Du Pont Films Japan Limited, type: S, thickness 38 μm) with a coating machine so that a thickness after dried might be 20 μm, and then dried to obtain a surface protective film.

### Comparative Example 2

Corona discharge treatment was given to one side of a low density polyethylene film (thickness: 60 μm, density: 0.92 g/cm³ (based on JIS K7112)), and then the above-mentioned acrylic based adhesive composition was applied to the corona discharge treated side with a coating machine so that a thickness after dried might be 20 μm, and then dried to obtain a surface protective film.

Following evaluation tests were performed using surface prot ctive films obtained in Example and Comparative examples.

[Evaluati n Test]

(1) Haze Evaluation

The obtained surfa e prote tive films were measured for haze values before heat treatment and after 1-hour heat treatment at 150° C. based on JIS K7136. Table 1 shows results.

(2) White Turbiness Evaluation

A variation between colors before heat treatment of the obtained surface protective films and after 1-hour heat treatment at 150° C. was observed by visual inspection, and evaluation was made based on following criteria. Table 1 shows result.

TABLE 1

| | Haze % | | |
|---|---|---|---|
| | Before heat | After heat | White |
| | treatment | treatment | turbiness |
| Example 1 | 3.3 | 3.4 | ∘ |
| Comparative example 1 | 4.0 | 12.0 | x |
| Comparative example 2 | 6.5 | — | x |

∘: no change observed
x: white turbiness is observed more than before heat treatment

As shown in the results of Table 1, since in a surface protective film of this invention an antistatic layer was formed, even after a heating process of 150° C.×1 hour, transparency of the surface protective film gave almost no change and a base material film did not demonstrate white turbiness. In Comparative example 2, the base material film was melted after heating process, which was not desirable on appearance.

What is claimed is:

1. A surface protective film for transparent ondu tive substrates protecting a surface opposite to a side of a conductive thin film of the transparent conductive substrates or a surface on a side of the conductive thin film, wherein an adhesive layer is formed on one side of a base material film, and an antistatic layer is formed on the other side.

2. The surface protective film for transparent conductive substrates according to claim 1, wherein said base material film is a film including polyethylene terephthalates and/or polyethylene naphthalates.

3. A transparent conductive substrate with a surface protective film comprising a conductive thin film on one side of a substrate and a hard coat layer or an anti-glare layer on the other side, and simultaneously comprising a adhesive layer of the surface protective film for the transparent conductive substrates according to claim 1 or 2 attached on a surface of the hard coat layer or the anti-glare layer, or on a surface on a side of the conductive thin film.

4. A transparent conductive substrate with a surface protective film comprising a conductive thin film on one side of a substrate, and simultaneously an adhesive layer of the surface protective film for a transparent conductive substrates according to claim 1 or 2 attached on a surface on the other side of the substrate or on a surface on a sid of the onductive thin film.
